(19) United States
(12) Patent Application Publication
(10) Pub. No.: US 2008/0106489 A1
(43) Pub. Date: May 8, 2008

(54) SYSTEMS AND METHODS FOR A HEAD-MOUNTED DISPLAY

(76) Inventors: LAWRENCE G. BROWN, Towson, MD (US); Yuval S. Boger, Baltimore, MD (US); Marc D. Shapiro, Parkville, MD (US)

Correspondence Address: KASHA LAW PLLC;4th Floor, 1750 Tysons Blvd., McLean, VA, 22102, US

(21) Appl. No.: 11/934,373

(22) Filed: Nov. 2, 2007

Related U.S. Application Data
(60) Provisional application No. 60/856,021, filed on Nov. 2, 2006.
(60) Provisional application No. 60/944,853, filed on Jun. 19, 2007.

(51) Int. Cl. G09G 5/00

(52) U.S. Cl. 345/9

(57) ABSTRACT

A head-mounted display with an upgradeable field of view includes for at least one eye an existing lens, an existing display, an added lens, and added display. The existing lens and the added lens are positioned relative to one another as though each of the lenses is tangent to the surface of a first sphere having a center that is located substantially at a center of rotation of the eye. The existing display and the added display are positioned relative to one another as though each of the displays is tangent to a surface of a second sphere having a radius larger than the first sphere's radius and having a center that is located at the center of rotation of the eye. A head mount for the head-mounted display includes two parallel rails, one or more brow pads, one or more top pads, and one or more back pads.

### CROSS-REFERENCE TO RELATED APPLICATION

This application claims the benefit of U.S. Provisional Patent Application Ser. No. 60/856,021 filed Nov. 2, 2006 and U.S. Provisional Patent Application Ser. No. 60/944,853 filed Jun. 19, 2007, which are herein incorporated by reference in their entireties.

### BACKGROUND OF THE INVENTION

1. Field of the Invention

Embodiments of the present invention relate to systems and methods for head-mounted video displays for presenting virtual and real environments. More particularly, embodiments of the present invention relate to systems and methods for presenting and viewing virtual and real environments on a head-mounted video display capable of providing a full field of view and including an array of display elements.

2. Background Information

Traditionally, displays for virtual environments have been used for entertainment purposes, such as presenting the environments for the playing of various video games. More recently, such displays have been considered for other applications, such as possible tools in the process of designing, developing, and evaluating various structures and products before they are actually built. These displays are used in many other applications including, but not limited to training, medical treatment, and large-scale data visualization. The advantages of using virtual displays as design and development tools include flexibility in modifying designs before they are actually built and savings in the costs of actually building designs before they are finalized.

More recently, displays for virtual environments have also been used to visualize real world environments. These displays have been used for, among other things, piloting unmanned aerial vehicles (UAVs) and remotely controlled robots. Displays for virtual environments have also been used for image enhancement, including night-vision enhancement.

To be a useful in virtual or real environments, however, a virtual display system must be capable of generating high fidelity, interactive environments that provide correct “feelings of space” (FOS) and “feelings of mass” (FOM). Such a system must also allow users to function “naturally” within the environment and not experience physical or emotional discomfort. It must also be capable of displaying an environment with dynamics matched to the dynamics of human vision and motor behavior so there is no perceptible lag or loss of fidelity.

FOS and FOM are personal perceptual experiences that are highly individual. No two people are likely to agree on FOS and FOM for every environment. Also, there are likely to be variations between people in their judgments of FOS and FOM within a virtual environment, as compared to FOS and FOM in the duplicated real environment. Thus, preferably a virtual display system will provide feelings of space and mass that are based on a more objective method of measuring FOS and FOM that does not rely on personal judgments of a particular user or a group of users.

With regard to human vision, typically there are “natural behaviors” in head and eye movements related to viewing and searching a given environment. One would expect, and a few studies confirm, that visual field restrictions (e.g., with head-mounted telescopes) result in a limited range of eye movements and increased head movements to scan a visual environment. Forcing a user of a virtual display system used as a design and development tool to adapt his or her behavior when working in a particular virtual environment could lead to distortions of visual perception and misjudgment on important design decisions. Thus, the ideal virtual display system will have sufficient field-of-view to allow normal and unrestricted head and eye movements.

Simulator sickness is a serious problem that has limited the acceptance of virtual reality systems. In its broadest sense, simulator sickness not only refers to feelings of dizziness and nausea, but also to feelings of disorientation, detachment from reality, eye strain, and perceptual distortion. Many of these feelings persist for several hours after use of a system has been discontinued. Most of the symptoms of simulator sickness can be attributed to optical distortions or unusual oculomotor demands placed on the user, and to perceptual lag between head and body movements and compensating movements of the virtual environment. Thus, preferably a virtual display system will eliminate simulator sickness.

One technology commonly used to present virtual environments are head-mounted video displays. A head-mounted display (“HMD”) is a small video display mounted on a viewer's head that is viewed through a magnifier. The magnifier can be as simple as a single convex lens, or as complicated as an off-axis reflecting telescope. Most HMDs have one video display per eye that is magnified by the display optics to fill a desired portion of the visual field.

Since the first HMD developed by Ivan Sutherland at Harvard University in 1968, there has always been a trade-off between resolution and field of view. To increase field of view, it is necessary to increase the magnification of the display. However, because video displays have a fixed number of pixels, magnification of the display to increase field of view is done at the expense of visual resolution (i.e., visual angle of the display pixels). This is because magnification of the display also increases magnification of individual display pixels, which results in a trade-off between angular resolution and field of view for HMDs that use single displays. Normal visual acuity is 1 minute of arc (20/20). Legal blindness is a visual acuity of 10 minutes of arc (20/200). The horizontal extent of the normal visual field is 140 degrees for each eye (90 degrees temporally and 50 degrees nasally). Thus, to fill the entire visual field with a standard SVGA image, one must settle for visual resolution that is worse than legal blindness.

One attempt to develop an HMD with both high visual resolution and a large monocular field of view was made by Kaiser Electro-Optic, Inc. (“KEO”) under a contract with the Defense Advanced Research Projects Agency (“DARPA”). KEO developed an HMD that employed a multi-panel “video wall” design to achieve both high resolution with relatively low display magnification and wide field of view. The HMD developed by KEO, called the Full Immersion Head-mounted Display (“FIHMD”), had six displays per eye. Each display of the multiple displays forming the video wall was imaged by a separate lens that formed a 3 by 2 array in front of each eye. The horizontal binocular field of view of the FIHMD was 156 degrees and the vertical was 50 degrees. Angular resolution depended on the number of pixels per display. The FIHMD had four minutes of arc (arcmin) per pixel resolution.

The FIHMD optics included a continuous meniscus lens (“monolens”) between the eye and six displays and a cholesteric liquid crystal (“CLC”) filter for each display. The meniscus lens served as both a positive refracting lens and as a positive curved mirror. The CLC reflected light from the displays that passed through the meniscus lens back onto the lens and then selectively transmitted the light that was reflected from the lens' curved surface. Some versions of the FIHMD optical design employed Fresnel lenses as part of the CLC panel to increase optical power. This so-called “pancake window” (also called “visual immersion module” or “VIM”), provided a large field of view that was achieved with reflective optics while folding the optical paths into a very thin package.

The FIHMD could not provide the quality and usability desired in such an HMD, and the seams between the optics and the optics themselves was a particularly large problem. The FIHMD had limitations imposed by its use of the VIM optics and the requirement for adequate eye relief to accommodate spectacles. The radius of curvature of the meniscus lens dictated the dimensions of the VIM and, coupled with the eye relief requirement, determined the location of the center of curvature of display object space. Although no documentation is available that discusses the rationale for the design, it appears that the centers of VIM field curvature for the FIHMD were set in the plane of a user's corneas. If the centers of the two VIM fields are separated by the typical interpupillary distance (68 mm), then the centers are located 12 mm behind the lens 23 of spectacles 22. This is the usual distance from a spectacle lens to the surface of the cornea. Because of this choice of centers, the FIHMD had problems with visibility of seams between the displays and with display alignment.

In view of the foregoing, it can be appreciated that a substantial need exists for systems and methods that can advantageously expand the capabilities and uses of HMDs.

### BRIEF SUMMARY OF THE INVENTION

One embodiment of the present invention is a head-mounted display with an upgradeable field of view. The head-mounted display includes an existing lens, an existing display, an added lens, and an added display. The existing display is imaged by the existing lens and the added display is imaged by the added lens. The existing lens and the existing display are installed in head-mounted display at the time of manufacture of the head-mounted display. The added lens and the added display are installed in the head-mounted display at a time later than the time of manufacture. The existing lens and the added lens are positioned relative to one another as though each of the lenses is tangent to a surface of a first sphere having a center that is located substantially at a center of rotation of an eye of a user. The existing display and the added display are positioned relative to one another as though each of the displays is tangent to a surface of a second sphere having a radius larger than the first sphere's radius and having a center that is located at the center of rotation of the eye. The added lens and the added display upgrade the field of view of the head-mounted display.

Another embodiment of the present invention is a method for extending the field of view of a head-mounted display. An added lens is positioned in the head-mounted display relative to an existing lens as though each of the lenses is tangent to a surface of a first sphere having a center that is located substantially at a center of rotation of an eye of a user of the head-mounted display. An added display is positioned in the head-mounted display relative to an existing display as though each of the displays is tangent to a surface of a second sphere having a radius larger than the first sphere's radius and having a center that is located at the center of rotation of the eye. The added lens and the added display extend the field of view of the head-mounted display. A first image shown on the existing display is aligned with a second image shown on the added display using a processor and an input device. The processor is connected to the head-mounted display and the input device is connected to the processor. Results of the alignment are stored in a memory connected to the processor.

Another embodiment of the present invention is a head mount for connecting a head-mounted display to the head of a user. The head mount includes two curved parallel rails, one or more brow pads, one or more top pads, and one or more back pads. The two curved parallel rails form a support structure for the head mount extending from near a brow of the head over a top of the head to near a back of the head. The two curved parallel rails are connected to each other and maintained in parallel by a brow cross rail at a brow end of the two curved parallel rails and by a back cross rail at the back end of the two curved parallel rails. The head-mounted display is connected to the brow cross rail for positioning in front of the user's eyes. The one or more brow pads are connected to the two curved parallel rails near the brow end of the two curve parallel rails. The one or more brow pads contact the brow of the user and allow the user to position the head mount on their brow so that the user's eyes are in front of the head-mounted display. The one or more top pads are connected to the two curved parallel rails near their centers. The one or more top pads are adjustable along and radially from the two curved parallel rails. The one or more top pads can be made to contact the top of the user's head and secure the head mount to the user's head. The one or more back pads are connected to the two curved parallel rails near the back end of the two curved parallel rails. The one or more back pads are adjustable along and radially from the two curved parallel rails. The one or more back pads can be made to contact the back of the user's head and secure the head mount to the user's head.

Another embodiment of the present invention is a telepresence system. The telepresence system includes a head-mounted display, a communications network, and an image sensor array. The head-mounted display includes a plurality of lens and a plurality of displays. The plurality of lenses are positioned relative to one another as though each of the lenses is tangent to a surface of a first sphere having a center that is located substantially at a center of rotation of an eye of a user. The plurality of displays are positioned relative to one another as though each of the displays is tangent to a surface of a second sphere having a radius larger than the first sphere's radius and having a center that is located at the center of rotation of the eye. Each of the displays corresponds to at least one of the lenses, and is imaged by the corresponding lens. The image sensor array includes a plurality of image sensor lenses and a plurality of image sensors. The plurality of image sensor lenses are positioned relative to one another as though each of the lenses is tangent to a surface of a third sphere. The plurality of image sensors are positioned relative to one another as though each of the image sensors is tangent to a surface of a fourth sphere having a radius larger than the third sphere's radius and having a center substantially the same as a center of the third sphere. Each of the image sensors corresponds to at least one of the image sensor lenses, and is imaged by the corresponding image sensor lens. The image sensor array is connected to the head-mounted display by the communications network. A second image sensor array can be added to the telepresence system so that there is one image sensor array per eye. An image sensor array per eye can provide a stereo telepresence experience.

### BRIEF DESCRIPTION OF THE DRAWINGS

FIG. 1 is a plan view at the time of manufacture of a head mounted display (HMD) with an upgradeable field of view (FOV), in accordance with an embodiment of the present invention.

FIG. 2 is a plan view at a time later than the time of manufacture of an HMD with an upgradeable FOV, in accordance with an embodiment of the present invention.

FIG. 3 is flowchart showing a method for extending the field of view of an HMD, in accordance with an embodiment of the present invention.

FIG. 4 is a schematic diagram of a perspective view of an exemplary HMD, in accordance with an embodiment of the present invention.

FIG. 5 is a schematic diagram of a side view of an exemplary HMD, in accordance with an embodiment of the present invention.

FIG. 6 is a plan view of a telepresence system, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

A tiled multiple display HMD is described in U.S. Pat. No. 6,529,331 (“the '331 patent”), which is herein incorporated by reference in its entirety. The HMD of the '331 patent solved many of the problems of the FIHMD, while achieving both high visual resolution and a full field of view (FOV). The HMD of the '331 patent used an optical system in which the video displays and corresponding lenses were positioned tangent to hemispheres with centers located at the centers of rotation of a user's eyes. Centering the optical system on the center of rotation of the eye was the principal feature of the HMD of the '331 patent that allowed it to achieve both high fidelity visual resolution and a full FOV without compromising visual resolution.

The HMD of the '331 patent used a simpler optical design than that used by the FIHMD. The HMD of the '331 patent used an array of lens facets that were positioned tangent to the surface of a sphere. The center of the sphere was located at an approximation of the “center of rotation” of a user's eye. Although there is no true center of eye rotation, one can be approximated. Vertical eye movements rotate about a point approximately 12 mm posterior to the cornea and horizontal eye movements rotate about a point approximately 15 mm posterior to the cornea. Thus, the average center of rotation is 13.5 mm posterior to the cornea.

The HMD of the '331 patent also used a multi-panel video wall design for the HMD's video display. Each lens facet imaged a miniature single element display, which was positioned at optical infinity or was adjustably positioned relative to the lens facet. The single element displays were centered on the optical axes of the lens facets. They were also tangent to a second larger radius sphere with its center also located at the center of rotation of the eye. The HMD of the '331 patent also included high resolution and accuracy head trackers and built-in eye trackers. One or more computers having a parallel graphics architecture drove the HMD of the '331 patent and used data from these trackers to generate high detail three-dimensional (3D) models at high frame rates with minimal perceptible lag. This architecture also optimized resolution for central vision with a roaming high level of detail window and eliminated slip artifacts associated with rapid head movements using freeze-frame. The result was a head-mounted display that rendered virtual environments with high enough fidelity to produce correct feelings of space and mass, and which did not induce simulator sickness.

Upgradeable FOV

One embodiment of the present invention is an HMD in which the FOV is upgradeable, or can be varied to a customers needs. Both the FIHMD and the HMD of the '331 patent used a plurality of displays to provide a full FOV. In both of these HMDs the positions of the displays were fixed and the FOV was, therefore, fixed. It turns out, however, that customers want HMDs with different configurations and capabilities.

An exemplary HMD of the present invention includes a variable number of individual display elements, or optical elements. A display element includes an optical lens and a video micro-display, where the video micro-display is imaged on the lens. Each display element contains a certain number of pixels. For example, a display element today may contain 800 pixels by 600 pixels. In the future, display elements will likely include many more pixels. In any event, a panoramic high resolution HMD is created by tiling display elements or stitching them together into an array of display elements. The FOV of the HMD is varied by using as many or as few of the display elements in the HMD as the customer requires.

The display elements can be placed in any orientation and in any arrangement. For example, the display elements can be placed in either a horizontal or a vertical orientation. The display elements can be arranged as a two by two, three by two, two by three, four by two, or five by three, depending on the customer's needs, for example. In other words, the display elements can be arranged to provide a wider or taller FOV. The arrangement of display elements in a display unit is not limited to a rectangular arrangement. For example, a display unit with 10 display elements can have three display elements in a top row, four display elements in a middle row, and three display elements in a bottom row. There is one display unit per eye, for example.

The display elements added to the HMD can also have a different resolution from the display elements already there. For example, display elements with a higher resolution can be added to the HMD. Adding display elements with a different or higher resolution results in an HMD with an upgradeable resolution.

The position of the array of display elements in the exemplary HMD of the present invention relative to the eye is also variable. As in the HMD of the '331 patent, the display elements of the HMD of the present invention can each lie on a tangent to a sphere with its center located at the center of rotation of the eye. The display elements of the HMD of the present invention can also each lie on a tangent to a sphere with its center located at the surface of the cornea of the eye, for example.

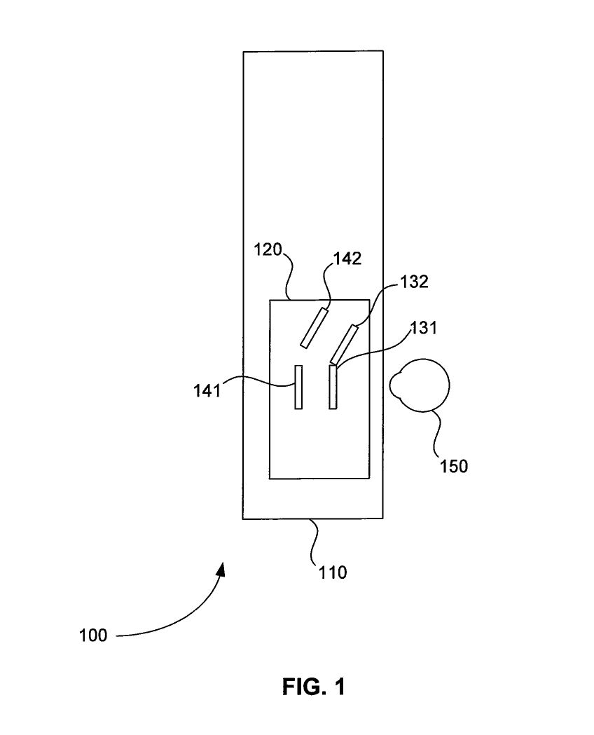

FIG. 1 is a plan view 100 at the time of manufacture of an HMD 110 with an upgradeable FOV, in accordance with an embodiment of the present invention. HMD 110 includes display unit 120 for displaying images to eye 150. At the time of manufacture display unit 120 includes lenses 131 and 132, and displays 141 and 142. Lens 131 images display 141 and lens 132 images display 142.

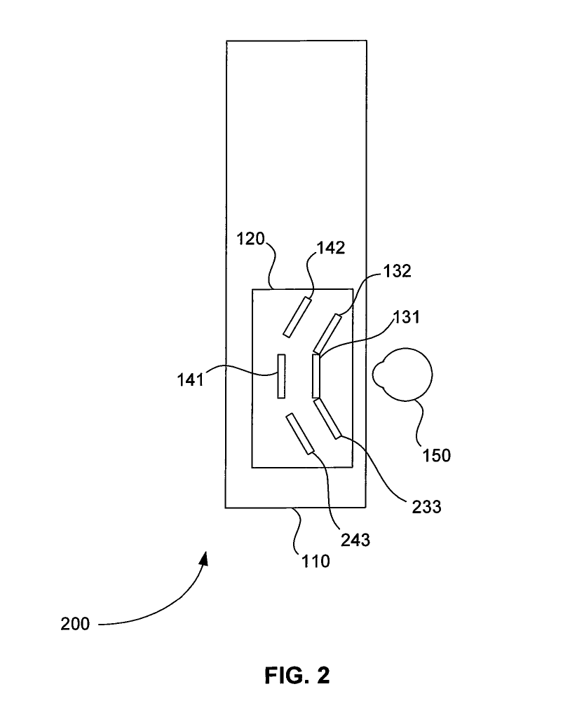

FIG. 2 is a plan view 200 at a time later than the time of manufacture of HMD 110 with an upgradeable FOV, in accordance with an embodiment of the present invention. At a time later than the time of manufacture of HMD 110, lens 233 and display 243 are added to display unit 120 in order to increase the FOV of HMD 110. Lens 233 is positioned so that lens 233 and, for example, lens 131 are both tangent to the surface of a first sphere having a center that is located substantially at the center of rotation of eye 150. Display 243 is then positioned so that lens 233 images display 243 and so that display 243 and display 141 are tangent to a surface of a second sphere having a radius larger than the first sphere's radius and having a center that is located substantially at the center of rotation of eye 150. The resolution of display 243 can be greater than, less than, or equal to the resolution of display 141.

HMD 110 is shown in FIGS. 1-2 as a monocular HMD. In another embodiment of the present invention, HMD 110 can also be a binocular HMD through the addition of a second display unit for an additional eye.

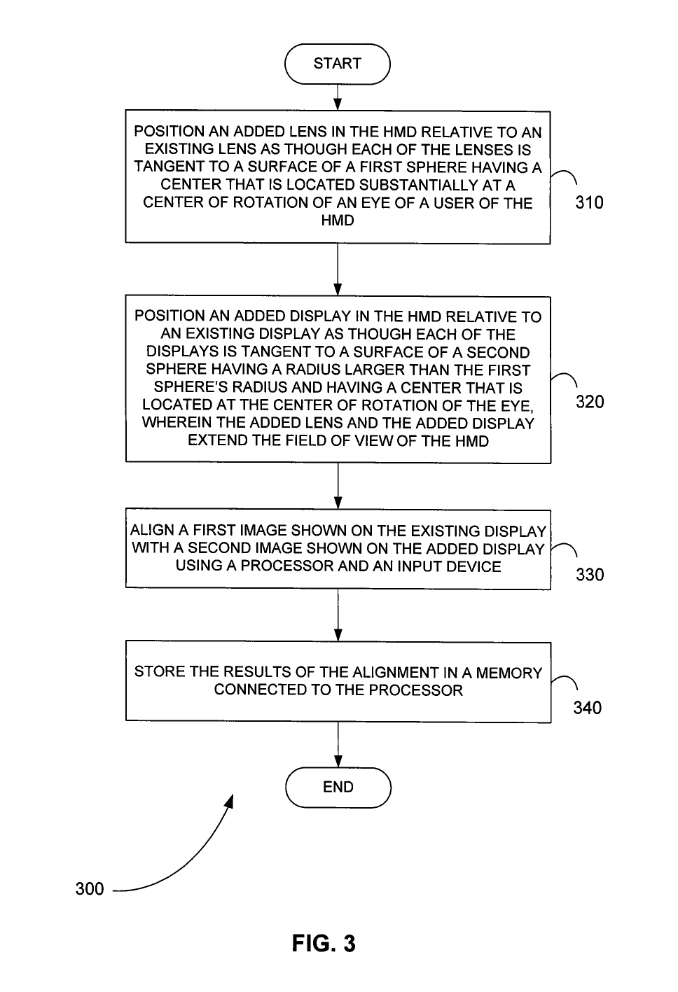

FIG. 3 is flowchart showing a method 300 for extending the field of view of an HMD, in accordance with an embodiment of the present invention.

In step 310 of method 300, an added lens is positioned in the HMD relative to an existing lens as though each of the lenses is tangent to a surface of a first sphere having a center that is located substantially at a center of rotation of an eye of a user of the HMD.

In step 320, an added display is positioned in the HMD relative to an existing display as though each of the displays is tangent to a surface of a second sphere having a radius larger than the first sphere's radius and having a center that is located at the center of rotation of the eye, wherein the added lens and the added display extend the field of view of the HMD.

In step 330, a first image shown on the existing display is aligned with a second image shown on the added display using a processor and an input device. The processor is connected to the HMD and the input device is connected to the processor, for example. The processor can be, but is not limited to, a computer, microprocessor, or application specific integrated circuit (ASIC). The input device can be, but is not, limited to a mouse, a touch pad, a track ball, or a keyboard.

Aligning a first image shown on the existing display with a second image shown on the added display includes aligning the orientation of the images, for example. In another embodiment of the present invention, aligning a first image shown on the existing display with a second image shown on the added display includes aligning colors of the images

In step 340, the results of the alignment are stored in a memory connected to the processor. The memory can be, but is not limited to a disk drive, a flash drive, or a random access memory (RAM). The results of the alignment are stored, for example, as a configuration file that is read each time the HMD is used.

Modular Design

Another embodiment of the present invention is an HMD that includes a modular design in which display elements can be replaced by other components. In other words, specific display elements can be left out of the display element array and replaced by other components. For example, an eye tracker is another component that is often integrated with an HMD. A common problem in integrating an eye tracker with an HMD is finding a suitable location for the eye tracker within the HMD. In the HMD of the present invention, an eye tracker can be placed almost anywhere within the HMD by simply removing a display element and replacing it with the eye tracker.

Vertically Offset FOV

Another embodiment of the present invention is an HMD that includes a mechanical device to vertically offset the FOV. As described above, an HMD of the present invention can have a plurality of FOV configurations. Some configurations are tall, some configurations are nearly square, some configurations are wide, and some configurations are narrow. A customer with any of these configurations might say, for example, that being able to see down is more important than being able to see up. Or, a customer with any of these configurations might say, for example, that being able to see up is more important than being able to see down.

In order to accommodate customers that have already purchased a particular FOV configuration, but still want to shift the FOV vertically, a mechanical device is added to the HMD of the present invention to shift the array of display elements vertically. The mechanical device is, for example, a bracket that holds the array of display elements. The mechanical device is used to balance the FOV of the HMD of the present invention, so that there is more FOV up, there is more FOV down, or there are equal amounts of FOV up and down.

Flexible Display HMD

Another embodiment of the present invention is an HMD that includes a full FOV and an array of display elements, where at least one of the display elements includes a flexible display. Flexible displays are, for example, materials that are flexible and bendable to many different shapes and can display video images. Flexible displays are currently under development and are just starting to come to market.

Flexible displays can be used in a panoramic, tiled HMD in a number of different ways. For example, a large sheet of flexible display can be cut into multiple flexible displays. These multiple flexible displays are then used in individual display elements in a display element array of the HMD of the present invention. Using flexible displays in display elements is advantageous, because each of the flexible displays can be curved in a mechanical way to compensate for geometric distortion in the lens of the display element. For example, if the optical lens of a display element exhibits a pin cushioning effect, a flexible display can be curved back to ameliorate this effect.

One large flexible display can also be used in a tiled HMD of the present invention. The flexible display is bent rather than curved. There are still display elements containing optical lenses, but there are no borders between video display elements. There is actual active image all the way through. This increases image overlap without requiring a change in any other optical parameter. Less optical overlap is then required, since it is not possible to see “off screen” though any given lens in the assembly.

See-Through HMD

There are at least two types of HMDs: immersive and see-through HMDs. Immersive HMDs allow viewing of virtual environments, as described above, and real environments (e.g. an application where video streams from remote cameras is presented in the HMD, or an application where a movie is presented in the HMD). In contrast, see-through HMDs allow information to be overlapped or allow information to be placed on top of images that are seen through the display. This overlapped or overlaid information can be, but is not limited to, information like telemetry, image enhancements, and additional detail.

Another embodiment of the present invention is an HMD that includes a full FOV and an array of display elements, and allows the user to see through the array of display elements. An HMD of the present invention allows the user to see through the array of display elements by including, for example, a beam splitter that superimposes the computer generated imagery on top of an actual world. An HMD of the present invention that allows the user to see through the array of display elements is also upgradeable with respect to the FOV, modular in that display elements can be removed and replaced with other components, and capable of including flexible displays.

Another embodiment of the present invention is video system that includes an HMD with a full FOV and an array of display elements coupled directly to one or more cameras, where the HMD allows the user to see through the array of display elements. The one or more cameras can be worn on a user's head, for example, and video from the one or more cameras can be augmented with computer-generated images. A computer generated image is a map, for example.

Video Processing Component

Another embodiment of the present invention is an electronic video processing component for driving video signals to an HMD that includes a full FOV and an array display elements. In conventional HMDs containing a plurality of display elements, each video display of a display element requires a separate video signal. As a result, a computer must generate multiple video signals. An electronic video processing component, or conversion box, of the present invention takes a single high resolution video or computer generated image and splits it into the individual images needed in order to drive the individual video displays. The electronic video processing component, therefore, includes a single video input and multiple outputs each corresponding to a display element, for example.

Sometimes two video signals are combined into a single input using such methods as field sequential or frame sequential multiplexing. In another embodiment of the present invention, an electronic video processing component can accept an input that has been combined from two or more video signals and spread this video over the panoramic FOV of an HMD that includes a full FOV and an array display elements.

The electronic video processing component can aid in enlarging or reducing part of the image and in creating special video effects (not just geometrical distortion). The electronic video processing component can also convert a non-stereoscopic image into two different sets of images (one for each eye) to achieve an illusion of stereoscopy.

In another embodiment of the present invention, the electronic video processing component includes two or more video inputs. For example, there is one high resolution video signal for the right eye, and there is a second high resolution video signal for the left eye. The result is still the same, however. The video processing component reduces the number of video signals that need to be provided to the HMD and thus reduces the complexity of using the system.

In another embodiment of the present invention, the electronic video processing component generates one or more video signals for one or more additional multi-screen displays. A multi-screen display is a projection dome, for example.

Because the display elements of a tiled HMD have to be at a certain position and have a certain rotation, assembly is difficult. In order to make assembly less difficult, position and rotation errors can be corrected electronically using the video processing component of the present invention. The video processing component of the present invention can also aid in color matching across individual video displays and can help correct for any geometrical distortion. The video processing component of the present invention includes, for example, a circuit board, a field programmable gate array (FPGA), or an application-specific integrated circuit (ASIC).

Convex Aspheric Lenses

Another embodiment of the present invention is an HMD that includes a full FOV and an array of display elements, where at least one of the display elements includes a convex aspheric lens. A convex aspheric lens produces a higher resolution image or higher quality image than a Fresnel lens. The image from a convex aspheric lens is sharper than a Fresnel lens, allowing more individual pixels on the display to be seen. A convex aspheric lens produces a higher contrast image than a Fresnel lens, so it is easier to distinguish blacks from whites, and the image looks less washed out overall. By using a convex aspheric lens it is possible to make a complete optical chain that is both less expensive and lighter than the optical components required when using Fresnel lenses and flat glass.

A convex aspheric lens is, for example, made out of glass, acrylic, or other plastics. Making a convex aspheric lens out of acrylic or plastic is advantageous, because the lens can be molded.

Molding Lenses

Another embodiment of the present invention is a process for molding lenses included in an HMD that includes a full FOV and an array of display elements. A lens is molded for an HMD of the present invention, for example, by molding each optical lens individually rather than cutting them from sheets of material. The molded parts are then glued together to form a portion of the array of display elements.

In another embodiment of the present invention, the entire array of optical lenses is molded in one piece. Liquid is poured into a mold in the shape of the array of optical lenses and is removed from the mold as one piece. Molding the entire array of optical lenses as one piece can potentially reduce alignment errors.

Orientation Alignment

Another embodiment of the present invention is a method of orienting the display elements of an HMD that includes a full FOV and an array of display elements. This method is implemented using software on a computer driving the HMD or using the electronic video processing component described above, for example. Lines, crosses, or some other calibration image is displayed on neighboring display elements. Using these lines and crosses, the user matches pixels along the borders between displays. From this matching, an algorithm finds the correct orientation for each display element to include yaw, pitch, and roll for each display. The algorithm attempts to minimize all differences between neighboring displays. Finally, the results from the user matching pixels and the algorithm minimizing differences are stored in a configuration file. The configuration file is then read by every application software program that generates imagery for the HMD.

In other words, an HMD of the present invention includes a software model or interface specification that tells an application software program how each display is oriented in terms of yaw, pitch, and roll position. If the application software generates images according to the specification, then the imagery will be displayed properly. The software model or interface specification is generated from the calibration step performed by the user, and the algorithm is used to minimize differences between neighboring displays. The user is asked to align display elements visually. The calibration algorithm then uses this information to calculate a transformation that defines the position of each display element. The transformation is stored as a configuration file, for example.

A user is asked, for example, to compare a cross located at a pixel defined by a certain row and column on one display element with a cross located at a pixel defined by the same row and column on a neighboring display element. The user should see the two pixels as lying on top of one another. However, because of various mechanical misalignments that are introduced when the HMD is manufactured, often the two pixels do not coincide. They are separated by some amount. As a result, the user can slide the crosses or pixels, so they do coincide. The calibration algorithm uses this feedback from the user to calculate the transformations for each display element.

Color Alignment

Another embodiment of the present invention is a method of aligning the colors of display elements of an HMD that includes a full FOV and an array of display elements. This method is implemented using software on a computer driving the HMD or using the electronic video processing component described above, for example. Different colors, patterns, and gradients are displayed on neighboring display elements. The user is asked to match the brightness and color properties of adjacent display elements. The feedback provided by the user is used by a calibration algorithm to create a transformation that is stored in the same configuration file used for orientation data, for example.

Both the orientation and color alignment method algorithms can be executed on a single processor or multiple processors. Some customers use multiple processors because it improves graphics processing.

Fixed Space Imaging

Another embodiment of the present invention is a method for presenting a fixed image in an HMD virtual environment. This method is implemented using software on a computer driving the HMD or using the electronic video processing component described above, for example. Standard video displayed in conventional HMDs can induce simulator sickness in some users. This simulator sickness is usually brought about when a user moves their head and the image remains fixed on the same portion of the retina.

One method of reducing simulator sickness in some users is to fix the video image in virtual space so that the image moves relative to the retina with any head movement. This method requires the use of a head tracker. Input is received from the head tracker. As the user's head moves, the virtual environment is moved relative to the user's retina in proportion to the head movement. This method is useful for watching content from digital video discs (DVDs), for example. This method provides a fixed virtual screen in a virtual living room, for example.

Monocular HMD

Another embodiment of the present invention is a monocular HMD that includes a full FOV and an array of display elements. In some applications, it is advantageous to have one eye looking at the outside world and the other eye viewing a panoramic view in an HMD. Such applications include, for example, movie directing or piloting an aircraft. The display elements of a monocular HMD of the present invention can each lie on a tangent to a sphere with its center located at the center of rotation of the eye, for example.

HMD Head Mount

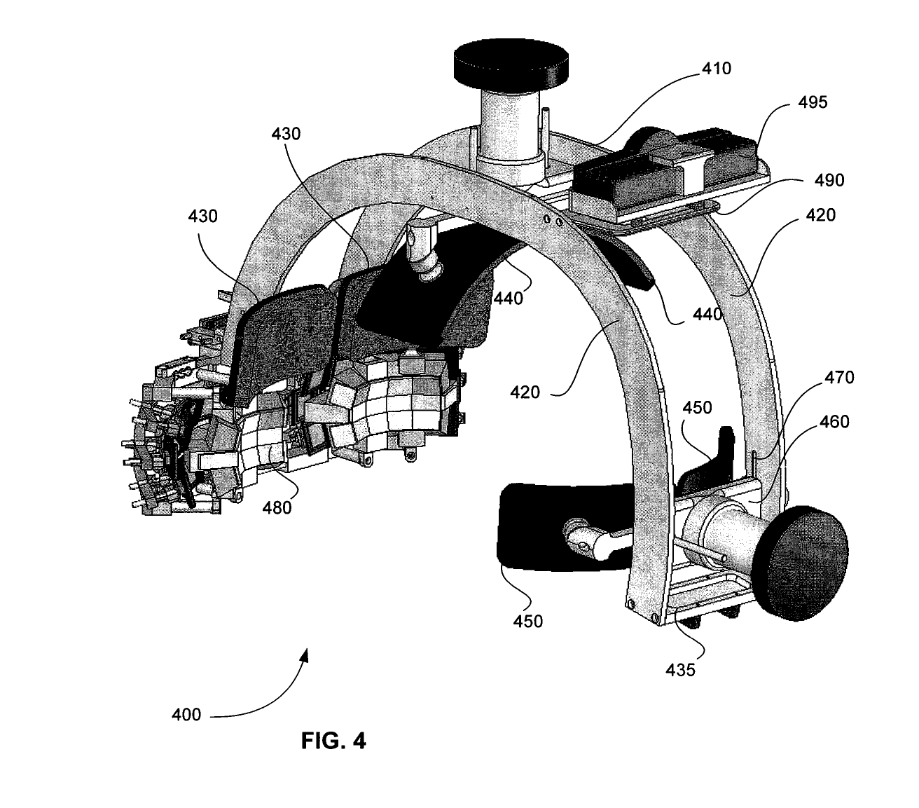

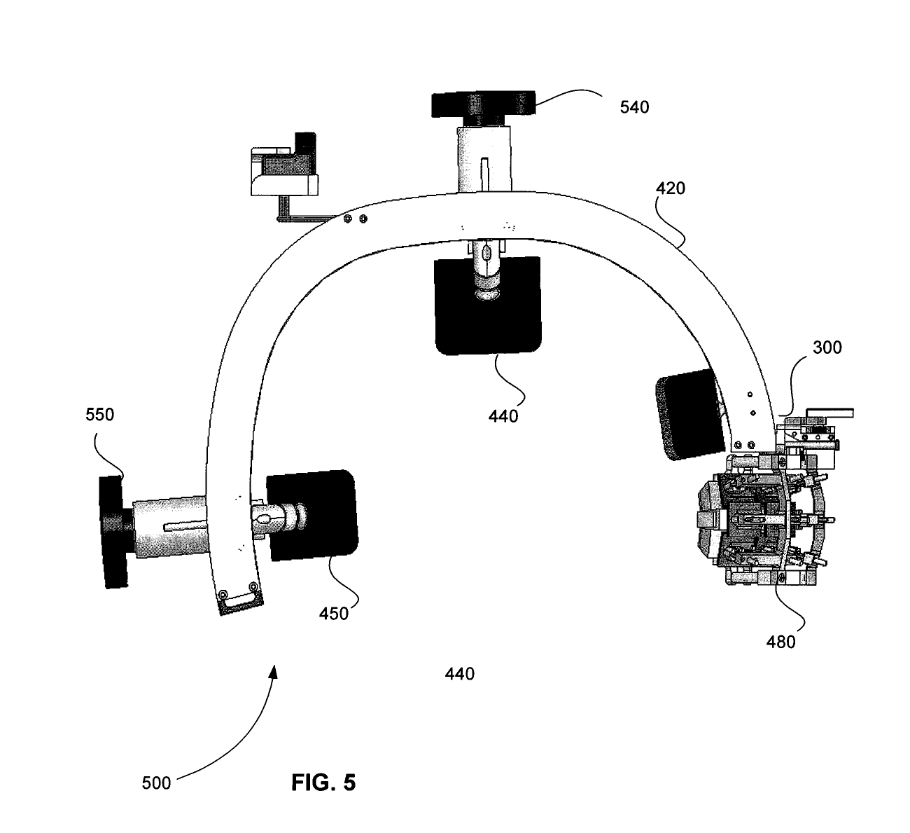

Another embodiment of the present invention is a head mount for an HMD that includes a full FOV and an array of display elements. FIG. 4 is a schematic diagram of a perspective view 400 of a head mount 410 for an HMD 480, in accordance with an embodiment of the present invention. FIG. 5 is a schematic diagram of a side view 500 of a head mount 410 for an HMD 480, in accordance with an embodiment of the present invention.

In FIG. 4, head mount 410 is shown including two thin curved and parallel rails 420 that extend from the front to the back over the top of a user's head (not shown). Two thin rails 420 are connected to each other and maintained in parallel by brow cross rail (not shown) at the brow end of two thin rails 420 and by back cross rail 435 at the back end of two thin rails 420. HMD 480 is connected to the brow cross rail for positioning in front of the user's eyes. Rails 420, the brow cross rail, and back cross rail 435 are formed from, for example, aluminum. In another embodiment of the present invention, rails 420, the brow cross rail, and back cross rail 435 are metal tubes. Electrical cables (not shown) are laid next to rails 420 and are covered by a plastic cover (not shown).

Pads 430, 440, and 450 are soft curved pads that extend inward from rails 420. Pads 430, 440, and 450 are what contact the user's head (not the rails). Brow pads 430 are connected to rails 420 near the brow end of rails 420 and contact the brow of a user. Brow pads 430 allow the user to position head mount 410 on their brow so that the user's eyes are in front of HMD 480. Top pads 440 are connected to rails 420 near their centers and contact the top of the user's head. Top pads 440 are adjustable along rails 420 and radially from rails 420 and allow the user to secure head mount 410 to the user's head. Back pads 450 are connected to rails 420 near the back end of rails 420 and contact the back of the user's head. Back pads 450 are adjustable along rails 420 and radially from rails 420 and allow the user to secure head mount 410 to the user's head.

As shown in FIG. 5, top pads 440 and back pads 450 are adjustable. Top pads 440 are attached, for example, to screw 540, and back pads 450 are attached to screw 550. Screws 540 and 550 allow top pads 440 and back pads 450 to move in or out or radially from rails 420, respectively. Returning to FIG. 4, top pads 440 and back pads 450 can also move along rails 420. The entire pad and screw assembly 460, for example, slides within curved channels 470 etched in rails 420 allowing back pads 450 to move along rails 420. Top pads 440 can be moved along rails 420 in a similar fashion. Both these adjustments allow the optics to get positioned correctly for people with a large variety of head sizes and shapes.

Head mount 410 can support HMDs that weigh a pound or more. Head mount 410 allows an open HMD design with minimal covering of the head surface so users do not feel encumbered by the head mount. Head mount 410 allows for free airflow and prevents HMD 480 from overheating. Head mount 410 can also include motion sensor cross rail 490 connected to rails 420 for mounting motion sensor 495 that can be used to determine the position of a user's head.

Adding a Display Element

Another embodiment of the present invention is a method for adding or removing a display element from an HMD that includes a full FOV and an array of display elements. First, the display element is physically added or removed from the HMD. If the display element is added to the HMD, the display element must be matched to the location where it is to be added, because display elements in different locations have different mechanical characteristics. Next, the display element is connected to or disconnected from the graphics adapter. The array of display elements are then calibrated using input from the user. Finally, the configuration file is modified to either add or remove information.

Controlling Robots

Another embodiment of the present invention is an HMD that includes a full FOV and an array of display elements and is used to control robotic vehicles. An HMD that includes a full FOV and an array of display elements can be coupled with a head tracker to control robotic vehicles or robots in a telepresence type of way. A robotic vehicle can include, but is not limited to, an unmanned aerial vehicle (UAV).

Viewing Real 3D Environments

Another embodiment of the present invention is an HMD that includes a full FOV and an array of display elements and is used to view real 3D environments. An HMD that includes a full FOV and an array of display elements can be coupled with a 3D scanner to capture and view a real 3D environment. Thus, a HMD that includes a full FOV and an array of display elements can be used to, for example, put a user in a real building, cockpit, or car.

Visual Telepresence System

Another embodiment of the present invention is visual telepresence system. This system includes camera or image sensors to capture images, a communications network to send images, and a display system to display images. Despite recent advances in some aspects of visualization technology, conventional display systems suffer from a significant inability to really immerse the user in a new visual environment. The display system of the visual telepresence system includes an ultra-wide FOV HMD. This HMD offers a FOV that nearly matches the unobstructed human visual field.

The optics of this HMD offer a FOV that is approximately 100 degrees tall by 150 degrees wide and is capable of high resolution throughout the entire field. The resolution can be, for example, three minutes of arc (arcmin). The HMD is integrated with a custom, Linux-based graphics cluster using commercial off-the-shelf (COTS) graphics that display high polygon models with high frame rates and create a complete simulation/virtual reality system.

This HMD combined with a custom camera system and appropriate software form a telepresence system capable of high-fidelity depth perception, FOV, and resolution. Such a telepresence system is useful for operators of robotic systems, by helping them avoid disorientation and reducing the likelihood that they will lose sight of the subject of interest.

Tiled HMD

The key attributes of an HMD are FOV, resolution, weight, eye relief, exit pupil, luminance, and focus. While the relative importance of these parameters can vary across applications, FOV and resolution are generally the first two attributes that potential users note when evaluating commercial HMDs. Generally, HMDs seek both a wide FOV and high resolution. However, as the displays in an HMD are magnified to give a larger FOV, the pixels on the display are magnified resulting in a trade-off between FOV and resolution. This trade-off is captured in the following equation that relates resolution and FOV: R=N/FOV, where N is the number of pixels along one dimension of the display and FOV is the angular FOV of that dimension. If FOV is in degrees, the R is in pixels per degree. R decreases with increasing FOV.

As the human eye is the final arbiter for an HMD, there are practical limits to the FOV and resolution required. Generally, the limit of human (horizontal) FOV is taken to be about 200 degrees wide for binocular vision. Although the limit of human visual resolution depends on the nature of the task used to measure it and the attributes of the target, the most common number used in the HMD design community for this limit is 60 pixels per degree (corresponding to a pixel size of one arcmin). Attributes of the target can include, but are not limited to, contrast, color, and ambient luminance.

Conventional HMDs have one miniature display per eye, which is typically a liquid crystal display (LCD) or a miniature CRT, and, therefore, suffer from the FOV and resolution trade-off problem. Generally, HMD manufacturers have settled for an HMD with good resolution but poor FOV.

Because of their small FOV, conventional HMDs are not capable of providing an immersive telepresence platform. With respect to HMD parameters, FOV has been shown to be the dominant factor in determining “presence.” Presence is the degree to which a person feels like they are in a different environment. In fact, FOV has been found to be nearly three times as strong a factor on presence than visual resolution, with increasing FOV providing increased levels of immersion.

Increased FOV also leads to stronger visually induced-self motion and increased performance and simulators. Increasing FOV is tied to better steering performance in piloting unmanned aerial vehicles (UAVs). In addition, evidence is accumulating to support the generally accepted hypothesis that greater presence leads to better performance.

In another embodiment of the present invention, an HMD uses a total of 15 miniature displays per eye, or a total of 30 displays per headset. By using a novel lens array that includes one lens for each display panel, the images of 30 displays are made to appear as one large continuous visual field. As a result, the wearer of the HMD is unaware of the tiled nature of the system. Each lens panel magnifies the image of the corresponding miniature display, and all of the magnified images overlap, yielding a large seamless image.

However, the total FOV of such an HMD is not simply the number of panels multiplied by the FOV of each panel. Consider the vertical field. If the vertical field has three panels, where each panel is 40 degrees tall, then the total vertical FOV is not 120 degrees, but closer to 100 degrees. This is because of the optical overlap between neighboring displays. A large amount of optical overlap is required to achieve the tiled display that appears seamless.

Tiled Camera Array

Another embodiment of the present invention is a tiled camera array that can match the FOV of the tiled HMD described above. The camera array can include two or more charged coupled device (CCD) or complementary metal oxide semiconductor (CMOS) image sensor cameras with custom optics. The tiled camera array need not correspond one-to-one with the tiled array of displays in an HMD. In a virtual space, a three-dimensional tiled hemisphere with a rectangular or trapezoidal tile for each camera in the tiled camera array is created. Each camera images is then texture mapped onto the corresponding tile in the virtual array. This produces conceptually a virtual hemisphere or dome structure with the texture mapped video on the inside of the structure.

Communications Network

A bandwidth problem arises when transferring captured video streams to computers or video processing units that display images in a tiled HMD. For example, each image goes from the camera through a frame grabber, and onto a computer (the “capture” computer), where it may undergo various transformations. The capture computer then sends the image out through its network card to a network where the image passes through one or more switches before passing through another network card to another computer (the “display” computer). The display computer sends the image to its graphics card, which texture maps it and displays it.

A fast network can handle a few high resolution images at video rates, but as the number of camera tiles grows, such a network bogs down. If the capture computers compress the images using, for example, moving pictures experts group version four (MPEG-4) compression, the network could handle the bandwidth. However, the display computers would have two uncompress, many simultaneous streams, and would bog down.

Another embodiment of the present invention is a method for stream-compressing texture-compressed images in such a way that decompressing the strain is very fast. In three dimensional graphics, a “texture” is an image drawn onto a three-dimensional polygon. Using textures in three dimensional models enhances their realism without affecting their polygon count. Texture compression has become commonplace because it provides three benefits. First, it takes less time to send a compressed texture to a graphics card. Second, more textures can be stored in the limited texture memory on a graphics card. Third, if the textures are being kept permanently on a disk, they take up less space.

A texture compression algorithm called S3TC is described in U.S. Pat. No. 5,956,431, which is herein incorporated by reference in its entirety. S3TC typically provides a six to one compression ratio. That is, the uncompressed texture is six times the size of the compressed texture. Even though other methods provide better compression ratios, S3TC is advantageous because it can be decoded quickly and because it is supported by most modern graphics cards.

Streaming video across a network requires even more compression, because of the limited bandwidth most networks provide. A common image resolution is the video graphics adapter (VGA) standard, which is 640 pixels by 480 pixels, for a total of just over 300,000 pixels. Typically color images use eight bits for each of the three color channels (red, green, and blue), which makes an uncompressed image just under 8 megabits (Mb) in size. Streaming a video sequence of such images at 30 frames per second makes over 220 Mb per second of bandwidth.

Fortunately, it is possible to compress streams, much more than images, because one frame is typically almost identical to the preceding frame. The older MPEG standard offers roughly 60 to one compression, and the newer variants of it, MPEG 2, and MPEG-4 are still better. Unfortunately, video streams cannot be used for textures, because today's graphics cards do not support video decompression of textures in hardware.

One embodiment of the present invention is a method to compress streams of already compressed textures. This method is called compressed-texture stream compression or CTSC. Using the CTSC, method, texture video is streamed across a network as follows. First, the capture computer captures an uncompressed image. Then, it compresses that image using S3TC. Then it uses CTSC to further compress the compressed texture by comparing it to the previous compressed texture. Then it sends the CTSC compressed frame across the network to the display computer. The display computer uses CTSC to decompress the stream, yielding a compressed texture. This texture is sent to the graphics card. This is a fast chain of events because CTSC is designed to be easy to decompress and modern graphics cards have hardware support for handling S3TC.

With a high bandwidth network and a large number of texture streams, it is advantageous for the display computer to only the compress those streams which are currently visible on the screen, which changes over time. Practical compression ratios are therefore limited by the need to periodically send uncompressed frames uncompressed by CTSC, but compressed by S3TC). When a previously off-screen, texture stream becomes on-screen, the display computer will be able to display it as soon as it sees an uncompressed frame in that stream

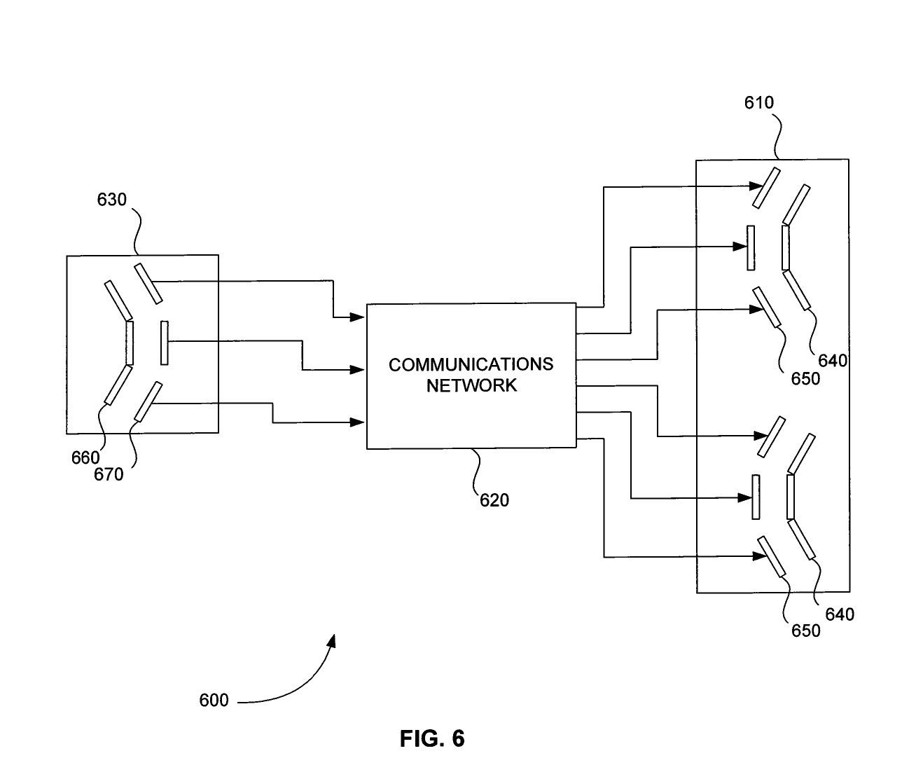

FIG. 6 is a plan view of a telepresence system 600, in accordance with an embodiment of the present invention. Telepresence system 600 includes HMD 610, communications network 620, and camera array 630. HMD 610 includes for each eye of a user a plurality of lenses 640 positioned relative to one another as though each of the lenses is tangent to a surface of a first sphere having a center that is located substantially at a center of rotation of an eye. HMD 610 also includes for each eye a plurality of displays 650 positioned relative to one another as though each of the displays is tangent to a surface of a second sphere having a radius larger than the first sphere's radius and having a center that is located at the center of rotation of the eye. Each of the displays 650 corresponds to at least one of the lenses 640, and is imaged by the corresponding lens.

Communications network 620 connects camera array 630 to HMD 610 and allows for efficient transmission of multiple video streams from camera array 630 into HMD 610.

Camera array 630 includes a plurality of camera lenses 660 positioned relative to one another as though each of the lenses is tangent to a surface of a third sphere. Camera array 630 also includes a plurality of cameras 670 positioned relative to one another as though each of the cameras is tangent to a surface of a fourth sphere having a radius larger than the third sphere's radius and having a center substantially the same as a center of the third sphere. Each of cameras 670 corresponds to at least one of camera lenses 660, and is imaged by the corresponding camera lens.

A camera of cameras 670 is, for example, a charge coupled device (CCD) camera. In another embodiment, a camera of cameras 670 includes a complementary metal oxide semiconductor (CMOS) image sensor. A lens of camera lenses 660 is, for example an achromatic lens.

In FIG. 6, camera array 630 is shown with three cameras and HMD 610 is shown with three displays for each eye. Camera array 630, however, can have fewer cameras the number of displays per eye of HMD 610.

In another embodiment of the present invention, a camera array forms the shape of a hemisphere. Camera elements are placed inside the hemisphere looking out through the lens array. The nodal points of all lens panels coincide at the center of a sphere, and mirrors are used to allow all the cameras to fit.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein advantageously expand the capabilities and uses of the HMD of the '331 patent. An HMD of the present invention has an upgradeable field view, allows interchange of modular components, allows the FOV of an existing system to be offset vertically, can include flexible displays, and can include convex aspheric lenses. A video processing component of the present invention allows an array of display elements to be driven from a single electronic component. Using a method of the present invention, convex aspheric lenses can be molded improving their optical characteristics. Using methods of the present invention, the orientation and color of display elements are aligned. Using a method of the present invention, a fixed space environment is created in virtual reality. A monocular HMD of the present invention includes an array of display elements and a full FOV for one eye. A head mount of the present invention provides multiple points of contact, height adjustment, and tension adjustment. Using a method of the present invention, display elements can be removed or added to an HMD including an array of display elements. An HMD of the present invention is used to control robotic vehicles. An HMD of the present is used to view real 3D environments virtually. An HMD coupled with a communications network and a camera array is used to provide a telepresence system with a large FOV.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A head-mounted display with an upgradeable field of view comprising for an eye of a user of the head-mounted display:
an existing lens;
an existing display that is imaged by the existing lens, wherein the existing lens and the existing display are installed at a time of manufacture of the head-mounted display;
an added lens; and
an added display that is imaged by the added lens,
wherein the added lens and the added display are installed at a time later than the time of manufacture,
wherein the existing lens and the added lens are positioned relative to one another as though each of the lenses is tangent to a surface of a first sphere having a center that is located substantially at a center of rotation of the eye,
wherein the existing display and the added display are positioned relative to one another as though each of the displays is tangent to a surface of a second sphere having a radius larger than the first sphere's radius and having a center that is located at the center of rotation of the eye, and
wherein the added lens and the added display upgrade the field of view of the head-mounted display.

2. The head-mounted display of claim 1, wherein the added display comprises a flexible display.

3. The head-mounted display of claim 1, wherein the added lens comprises a convex aspheric lens.

4. The head-mounted display of claim 1, wherein the head-mounted display comprises a monocular head-mounted display.

5. The head-mounted display of claim 1, wherein the added display resolution is greater than the existing display resolution.

6. The head-mounted display of claim 1, further comprising a video processing component that accepts a video signal and reconfigures the video signal into one or more video signals that drive the existing display.

7. The head-mounted display of claim 6, wherein the video processing component generates one or more video signals for one or more additional multi-screen displays.

8. The head-mounted display of claim 1, further comprising a beam splitter that allows a real image to been seen through the added display.

9. A method for extending the field of view of a head-mounted display, comprising:
positioning an added lens in the head-mounted display relative to an existing lens as though each of the lenses is tangent to a surface of a first sphere having a center that is located substantially at a center of rotation of an eye of a user of the head-mounted display; and
positioning an added display in the head-mounted display relative to an existing display as though each of the displays is tangent to a surface of a second sphere having a radius larger than the first sphere's radius and having a center that is located at the center of rotation of the eye, wherein the added lens and the added display extend the field of view of the head-mounted display, and
aligning a first image shown on the existing display with a second image shown on the added display using a processor and an input device, wherein the processor is connected to the head-mounted display and the input device is connected to the processor; and
storing results of the alignment in a memory connected to the processor.

10. The method of claim 9, wherein aligning a first image shown on the existing display with a second image shown on the added display comprises aligning an orientation of the first image with a second image.

11. The method of claim 9, wherein aligning a first image shown on the existing display with a second image shown on the added display comprises aligning a color of the first image with a second image.

12. The method of claim 9, wherein a real image can be seen through the added display.

13. A head mount for connecting a head-mounted display to a head of a user comprising:
two curved parallel rails forming a support structure for the head mount extending from near a brow of the head over a top of the head to near a back of the head that are connected to each other and maintained in parallel by a brow cross rail at a brow end of the two curved parallel rails and by a back cross rail at the back end of the two curved parallel rails, wherein the head-mounted display is connected to the brow cross rail for positioning in front of the user's eyes;
one or more brow pads connected to the two curved parallel rails near the brow end that contact the brow of the user and allow the user to position the head mount on their brow so that the user's eyes are in front of the head-mounted display;
one or more top pads connected to the two curved parallel rails near their centers that are adjustable along and radially from the two curved parallel rails so that the one or more top pads can be made to contact the top of the user's head and secure the head mount to the user's head; and
one or more back pads connected to the two curved parallel rails near the back end that are adjustable along and radially from the two curved parallel rails so that the one or more back pads can be made to contact the back of the user's head and secure the head mount to the user's head.

14. The head mount of claim 13, wherein the two curved parallel rails, the brow cross rail, and the back cross rail comprise aluminum.

15. The head mount of claim 13, wherein the two curved parallel rails, the brow cross rail, and the back cross rail comprise metal tubes.

16. The head mount of claim 13, wherein the one or more brow pads, the one or more top pads, and the one or more back pads comprise soft curved pads.

17. The head mount of claim 13, further comprising an electrical cable channel and cover along the two curved parallel rails for housing electrical cables connected to the head-mounted display.

18. The head mount of claim 13, further comprising a motion sensor cross rail connected to the two curved parallel rails and located between the brow cross rail and back cross rail for mounting a motion sensor.

19. The head mount of claim 13, wherein a top screw assembly is used to adjust the one or more top pads radially from the two curved parallel rails.

20. The head mount of claim 19, wherein the top screw assembly moves along curved channels in the two curved parallel rails to adjust the one or more top pads along the curved parallel rails.

21. The head mount of claim 13, wherein a back screw assembly is used to adjust the one or more back pads radially from the two curved parallel rails.

22. The head mount of claim 21, wherein the back screw assembly moves along curved channels in the two curved parallel rails to adjust the back pads along the curved parallel rails.

23. A telepresence system comprising:
a head-mounted display comprising for an eye of a user of the head-mounted display
a plurality of lenses positioned relative to one another as though each of the lenses is tangent to a surface of a first sphere having a center that is located substantially at a center of rotation of the eye; and
a plurality of displays positioned relative to one another as though each of the displays is tangent to a surface of a second sphere having a radius larger than the first sphere's radius and having a center that is located at the center of rotation of the eye, wherein each of the displays corresponds to at least one of the lenses, and is imaged by the corresponding lens;
a communications network; and
an image sensor array comprising
a plurality of image sensor lenses positioned relative to one another as though each of the lenses is tangent to a surface of a third sphere; and
a plurality of image sensors positioned relative to one another as though each of the image sensors is tangent to a surface of a fourth sphere having a radius larger than the third sphere's radius and having a center substantially the same as a center of the third sphere, wherein each of the image sensors corresponds to at least one of the image sensor lenses, and is imaged by the corresponding image sensor lens and wherein the image sensor array is connected to the head-mounted display by the communications network.

24. The telepresence system of claim 23, wherein the plurality of image sensors comprises a charge coupled device.

25. The telepresence system of claim 23, wherein the plurality of image sensors comprises a complementary metal oxide semiconductor image sensor.

26. The telepresence system of claim 23, wherein the plurality of image sensor lenses comprises an achromatic lens.

27. The telepresence system of claim 23, wherein a number of image sensors of the plurality of image sensors is less than a number of displays of the plurality of displays.

28. The telepresence system of claim 23, wherein the communication network comprises a textures.
